(19) United States
(12) Patent Application Publication
(10) Pub. No.: US 2009/0083658 A1
(43) Pub. Date: Mar. 26, 2009

(54) PORTABLE TERMINAL

(75) Inventors: Atsushi ITO, Kawasaki (JP); Iriichi OSANAI, Kawasaki (JP); Eriko ITO, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/233,012

(22) Filed: Sep. 18, 2008

(30) Foreign Application Priority Data
Sep. 20, 2007 (JP) 2007-244010

(51) Int. Cl. G06F 3/048

(52) U.S. Cl. 715/781

(57) ABSTRACT

According to an aspect of an embodiment, a portable terminal having a display screen for displaying a plurality of emails on the display screen, the portable terminal includes: a receiving module for receiving a plurality of emails each having a body; a first display processing module for displaying the body of the email on the display screen; a detector for detecting the last of the body displayed on the display screen; and a second display processing module for displaying on the display screen a list of the plurality of the emails and status of each of the emails indicating whether the last of the body of each of the emails has been displayed.

### BACKGROUND OF THE INVENTION

1. Field of the Invention

The invention relates to a portable terminal for displaying emails.

2. Description of the Related Art

With the recent progress of communication technology, users of portable terminals (cell phones, etc.) have had more opportunities to send or receive an email. Such a portable terminal properly displays various types of information about an email on a display screen such as a liquid crystal monitor. Proper display enhances the usability of email functions.

A portable terminal displays a received email list screen and a received email detail screen on one display module. The body or the like of a received email selected on the received email list screen is displayed on the received email detail screen. The user of the portable terminal views the body of the received email selected from the list of received emails with the received email list displayed. A technique related to the above techniques is disclosed in Japanese Laid-open Patent Publication No. 2005-77936.

However, if the user wants to select a desired received email from among received emails displayed in the list, the user must move the email selected (highlighted) on the list screen upward or downward by pressing the up or down key of the cell phone. That is, the user must move the selected email to the desired received email while passing through received emails that the user will not view. A problem here is that the cell phone cannot determines whether each of the passed-through received emails is an email that has actually been viewed by the user or an email that has been just passed through. That is, the cell phone cannot properly indicate on the screen whether each received email is a read email or an unread email.

### SUMMARY OF THE INVENTION

According to an aspect of an embodiment, a portable terminal having a display screen for displaying a plurality of emails on the display screen, the portable terminal includes: a receiving module for receiving a plurality of emails each having a body; a first display processing module for displaying the body of the email on the display screen; a detector for detecting the last of the body displayed on the display screen; and a second display processing module for displaying on the display screen a list of the plurality of the emails and status of each of the emails indicating whether the last of the body of each of the emails has been displayed.

### BRIEF DESCRIPTION OF THE DRAWINGS

FIG. 1A, FIG. 1B, FIG. 1C, and FIG. 1D are explanatory drawings showing an email display concept according to an embodiment of the invention;

FIG. 2 is a drawing showing an example of a display screen on which an email list and an email body are displayed simultaneously;

FIG. 3 is a block diagram showing a configuration of a portable terminal according to this embodiment;

FIG. 4A and FIG. 4B are flowcharts showing operation steps of an email processing module;

FIG. 5 is a table showing an example configuration of a key event assignment table;

FIG. 6 is a flowchart showing operation steps to be performed by a list display processing module;

FIG. 7 is a flowchart showing operation steps to be performed by a body display processing module;

FIG. 8A and FIG. 8B are flowcharts showing operation steps to be performed by the portable terminal when the email body is scrolled;

FIG. 9A and FIG. 9B are drawings showing a process in which the end of the email body is displayed by scrolling the email body;

FIG. 10A and FIG. 10B are flowcharts showing operation steps to be performed by the portable terminal when the email body is enlarged or reduced;

FIG. 11 is a table showing an example configuration of an enlargement/reduction level table;

FIG. 12A, FIG. 12B, FIG. 12C, FIG. 12D, and FIG. 12E are drawings showing a process for enlarging the email body and a process for reduction the email body;

FIG. 13A, FIG. 13B, and FIG. 13C are drawings showing the sizes of the display areas of an email list screen and an email body screen;

FIG. 14A and FIG. 14B are drawings showing an example of the email list screen in which the senders of received emails are displayed on the email list; and

FIG. 15 is a diagram showing a computer for executing an email display program.

### DESCRIPTION OF THE PREFERRED EMBODIMENTS

One embodiment of a portable terminal according to the invention will hereinafter be described with reference to the drawings.

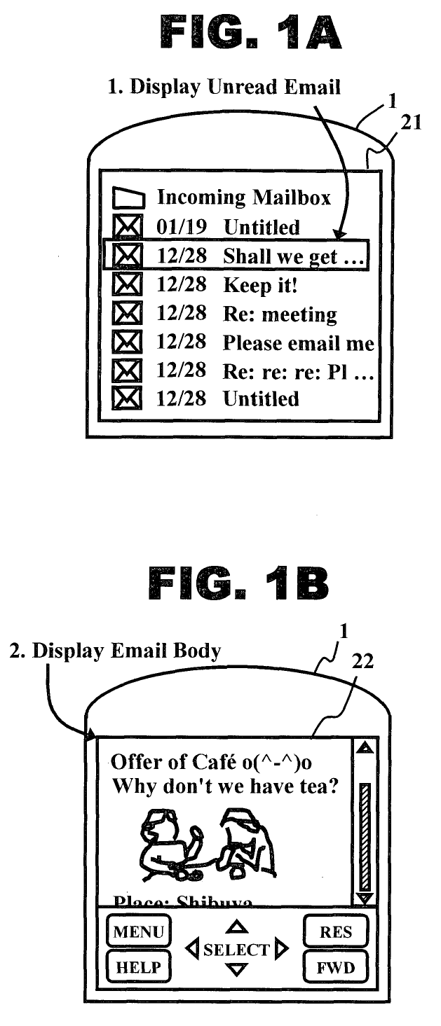

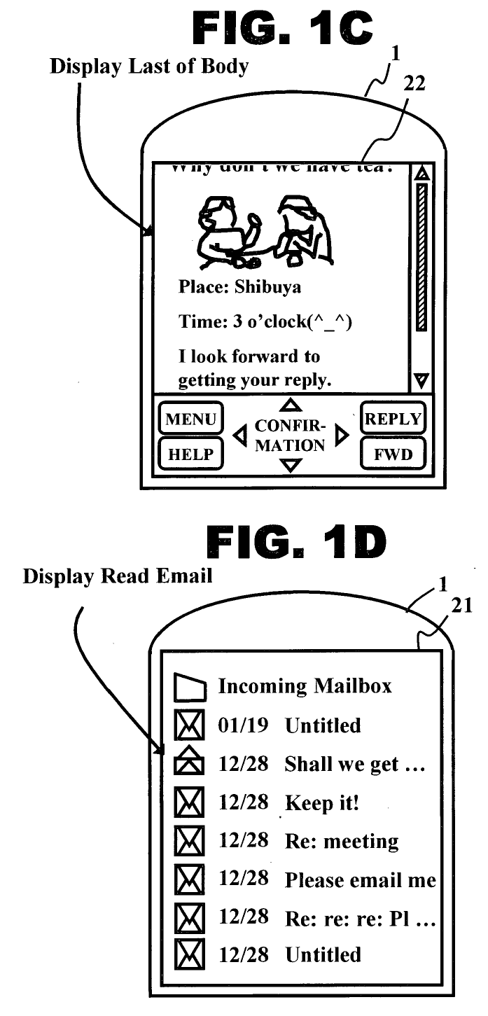

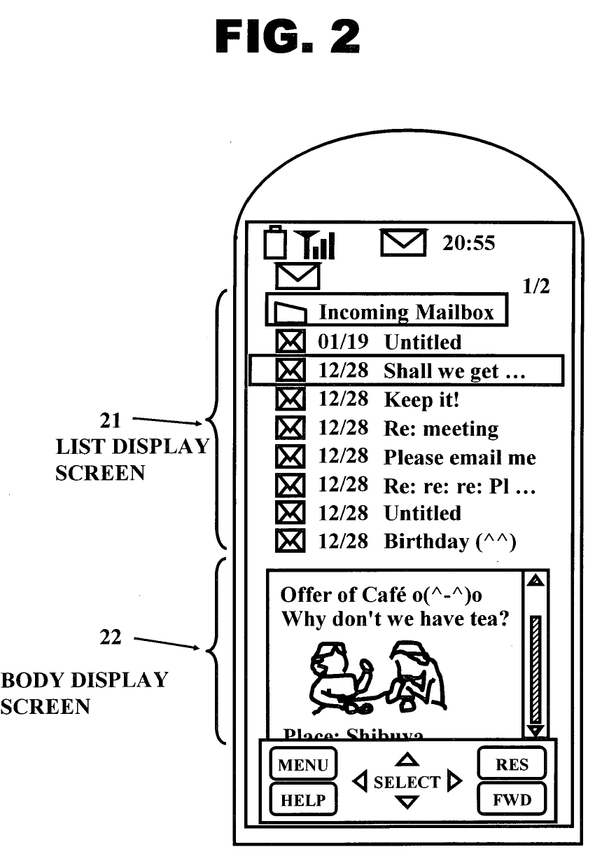

FIG. 1A, FIG. 1B, FIG. 1C, FIG. 1D, and FIG. 2 are explanatory drawings showing an email display concept according to this embodiment. If a portable terminal 1 displays a received email, first, it displays an email list screen (list display screen) 21 on a display screen. When the user selects a desired received email on the email list screen 21, the portable terminal 1 displays the body of the selected received email on an email body screen (body display screen) 22. For example, the portable terminal 1 is a cell phone.

When receiving an email, the portable terminal 1 displays the title, reception date, and the like of the received email on the email list screen 21.

The portable terminal 1 indicates on the email list screen 21 that each received email is an unread email (indicates information indicating an unread status) (FIG. 1A). When the user selects an unread received email displayed on the email list screen 21, the portable terminal 1 displays the body of the selected email on the email body screen 22 (FIG. 1B).

Subsequently, when the user performs an operation for scrolling the email body on the email body screen 22, the portable terminal 1 performs a scroll process. Thus, a following part (undisplayed part) of the email body is displayed on the email body screen 22. If the user performs an operation for scrolling the email body down to the end thereof, the portable terminal 1 displays the end of the email body (FIG. 1C).

If the email list screen 21 is displayed after the end of the email body is displayed on the email body screen 22, the portable terminal 1 indicates on the email list screen 21 that the email, whose body's end has been displayed, is a read email indicates information indicating a read state (FIG. 1D).

In this way, the portable terminal 1 properly indicates on the email list screen 21 whether each of the received emails displayed on the email list screen 21 is a read email or an unread email. Even if the body of a received email is displayed due to a misoperation of the portable terminal 1 performed by the user, the displayed email remains an unread email unless the end of the email body is displayed.

As shown in FIG. 2, the portable terminal 1 is allowed to display both the email list screen 21 and email body screen 22 in one display screen. In this case, the portable terminal 1 displays, on the email body screen 22, the body or the like of a received email selected (specified) on the email list screen 21.

The selected email is moved on the email list screen 21, for example, according to the number of presses of the up or down key of the cross key by the user, while the body of the selected email is displayed on the email body screen 22.

In this case, the portable terminal 1 displays the body of the selected email on the email body screen 22 without having to receive an instruction (for example, a press of the confirmation button) for displaying the body of the email. Thus, if the user wants to view the body of another email, the user need not open the email list screen 21 again. This reduces the number of key operations to be performed by the user. That is, the user performs a smaller number of key operations to display the body of a desired email on the email body screen 22.

Subsequently, if the end of the body of the email is displayed on the email body screen 22, the portable terminal 1 indicates on the email list screen 21 that the selected received email is a read email.

In this way, even if both the email list screen 21 and email body screen 22 are displayed (hereafter referred to as both the list and body are displayed) on the display screen, the portable terminal 1 properly indicates on the email list screen 21 whether each of the received emails displayed on the email list screen 21 is a read email or an unread email.

Also, even if the body of the selected email is displayed on the email body screen 22 without receiving an instruction for displaying the body of the email from the user, the portable terminal 1 is allowed to determine whether each received email is an email that has been actually viewed or an email that has been just passed through on the email list screen 21.

### Example of Portable Terminal Having Function of Displaying Both List and Body

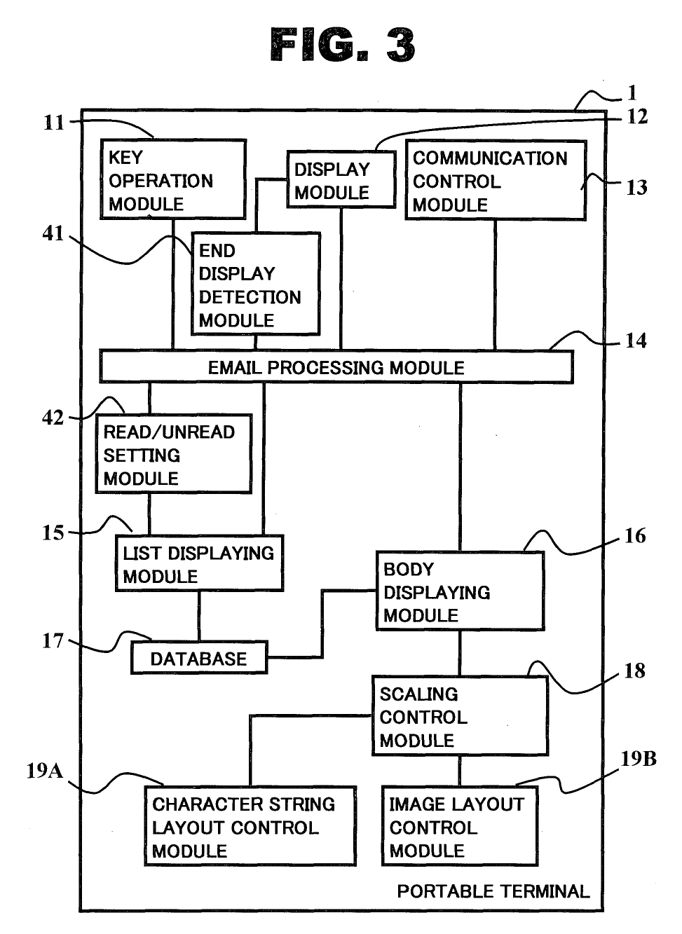

FIG. 3 is a block diagram showing a configuration of the portable terminal according to this embodiment.

The portable terminal 1 is a communication terminal having email functions, such as a cell phone. The portable terminal 1 indicates on the email list screen 21 whether each of received emails is a read email or an unread email while displaying both the list and body.

The portable terminal 1 includes a key operation module 11, a screen display module (display module) 12, a communication control module (receiving module) 13, an email processing module 14, a list displaying module (a second display processing module) 15, a body displaying module (a first display processing module) 16, a database 17, a scaling control module 18, a character string layout control module 19A, an image layout control module 19B, an end display detection module (an end detection module or a detector) 41, and a read/unread setting module (read/unread management module) 42. The email processing module 14, list displaying module 15, and body displaying module 16 may be collectively referred to as a display aspect control module.

The key operation module 11 receives various instructions from the user. The key operation module 11 includes multiple keys such as a numeric keypad and a cross key. The key operation module 11 sends, to the email processing module 14, a key event (a scroll-down process, etc.) corresponding to an instruction (a press of a button) inputted by the user.

The screen display module 12 displays the email body screen 22, email list screen 21, or the like on the display screen according to an instruction given by the email processing module 14, list displaying module 15, body displaying module 16, or the like. The screen display module 12 is, for example, a liquid crystal display, an electroluminescent (EL) display, a light-emitting diode (LED) display, etc.

The communication control module 13 controls transmission and reception of emails. The communication control module 13 sends an email received from another communication terminal to the email processing module 14 and sends an email that the email processing module 14 has instructed the communication control module 13 to send, to another communication module. The communication control module 13 includes receiving module for receiving the email from another communication terminal (or base station) and sending module for sending the email to from another communication terminal (or base station).

The email processing module 14 gives various instructions to the key operation module 11, screen display module 12, communication control module 13, list displaying module 15, body displaying module 16, end display detection module 41, and read/unread setting module 42 according to various types of information sent from these components. For example, the email processing module 14 sends an instruction for creation of the email list screen 21 to the list displaying module 15, as well as sends an instruction for creation of the email body screen 22 to the body displaying module 16. Each time the email processing module 14 receives a key event assigned to the email list display, it sends the key event to the list displaying module 15. Also, each time the email processing module 14 receives a key event assigned to the email body display, it sends the key event to the body displaying module 16.

The list displaying module 15 displays the email list screen 21 on the display screen according to an instruction from the email processing module 14. Also, the list displaying module 15 performs a process corresponding to a key event assigned to the email list display among key events sent from the key operation module 11 to the email processing module 14. Once the end of the body of an email has been displayed, the list displaying module 15 according to this embodiment changes the read/unread status of the email from “unread” to “read” so that this email is displayed as a read email on the email list screen 21.

The body displaying module 16 displays the email body screen 22 on the display screen according to an instruction from the email processing module 14. Also, the body displaying module 16 performs a process corresponding to a key event assigned to the email body display among key events sent from the key operation module 11 to the email processing module 14. The body displaying module 16 changes the display aspect of an email body displayed on the email body screen 22 by performing an enlargement process, a reduction process, a scroll process, or the like on the email body.

The scaling control module 18 controls enlargement or reduction of the email body displayed on the email body screen 22 according to an instruction from the body displaying module 16. The character string layout control module 19A adjusts the fold-back positions of character strings displayed on the email body screen 22 according to an instruction from the scaling control module 18. The image layout control module 19B changes the sizes of images displayed on the email body screen 22 according to an instruction from the scaling control module 18.

The database 17 is a storage means, such as a memory, for storing the list, bodies, confirmation statuses (read or unread), and like of received emails.

The end display detection module 41 detects whether the end of the body of an email has been displayed on the email body screen 22. The read/unread setting module 42 manages the read/unread status of a received email and causes the email list screen 21 to display information indicating the read/unread status. Upon receipt of notification that the end of the body of an email has been displayed from the end display detection module 41, the read/unread setting module 42 updates the confirmation status of the received email from “unread” to “read” in the database 17.

Operation Steps to be Performed by Portable Terminal 1

Hereafter, operation steps to be performed by the portable terminal 1 will be described. First, operation steps to be performed by the portable terminal 1 when the list of received emails and the body of a received email are displayed simultaneously will be described in the order of operations steps to be performed by the email processing module 14, operation steps to be performed by the list displaying module 15, and operation steps to be performed by the body displaying module 16. Next, operation steps to be performed by the portable terminal 1 when the confirmation status of the received email (information indicating whether the email is a read email or an unread email) is updated after it is detected that the end of the body of the email has been displayed will be described in detail.

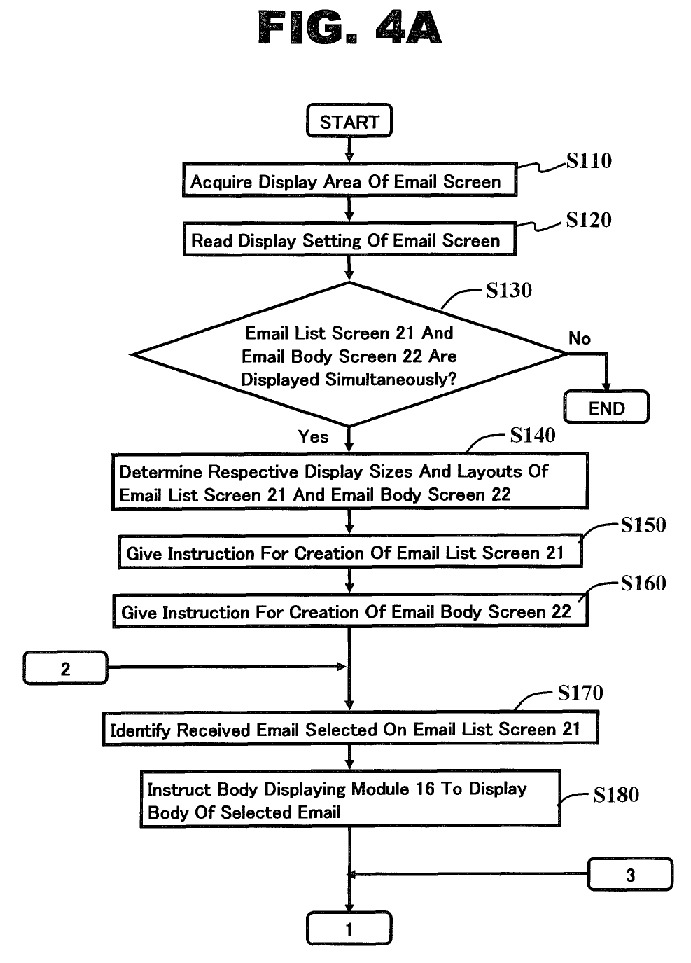

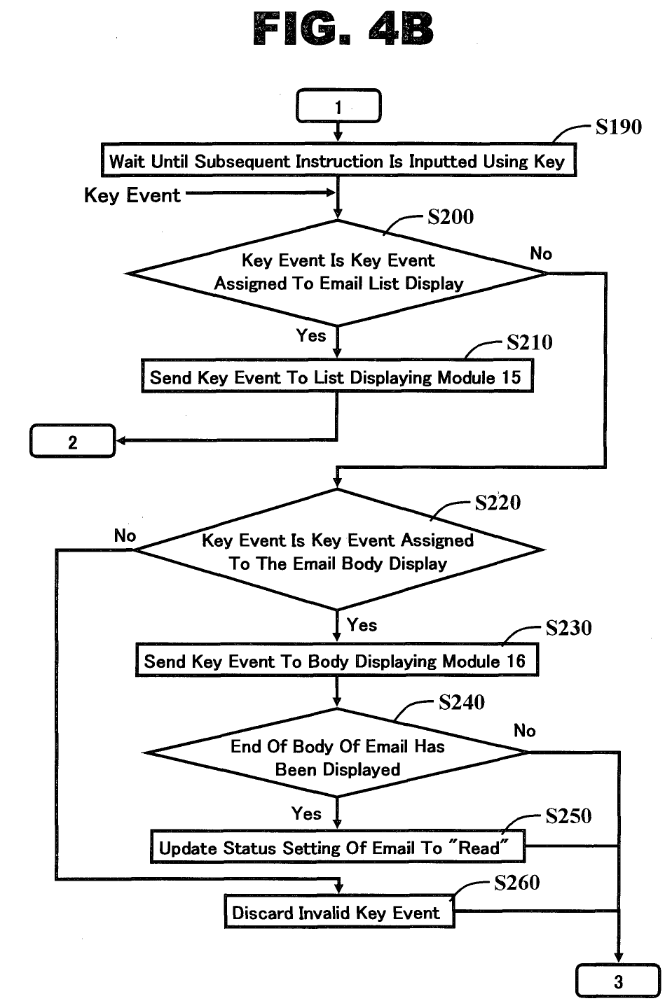

FIG. 4A and FIG. 4B are flowcharts showing operation steps of the email processing module. When the user selects the email functions from the menu of the portable terminal 1, the portable terminal 1 starts the email functions (email processing module 14, etc.).

The email processing module 14 of the portable terminal 1 acquires the display area (screen size) of the email screen from a predetermined memory (not shown) or the like (step S110). Also, the email processing module 14 reads the display setting of the email screen from a predetermined memory or the like (step S120).

The email processing module 14 determines whether the read email screen display setting is a setting for displaying the email list screen 21 and email body screen 22 simultaneously (setting for displaying both the list and body) (step S130).

If the read setting is a setting for displaying both the list and body, the email processing module 14 determines the respective display sizes and layouts of the email list screen 21 and email body screen 22 so as to display the email list screen 21 and email body screen 22 simultaneously (step S140). The display sizes and layouts may be predetermined default display sizes and layouts or may be display sizes and layouts determined according to instructions inputted by the user using the key operation module 11. For example, as shown in FIG. 2, the email processing module 14 sets the email list screen 21 in the upper half of the full display screen and the email body screen 22 in the lower half thereof.

The email processing module 14 gives an instruction for creation of the email list screen 21 to the list displaying module 15 (step S150). Also, the email processing module 14 gives an instruction for creation of the email body screen 22 to the body displaying module 16 (step S160). Further, the email processing module 14 sends the display size and layout of the email list screen 21 to the list displaying module 15, as well as sends the display size and layout of the email body screen 22 to the body displaying module 16.

Subsequently, the email processing module 14 identifies a received email selected on the email list screen 21 according to information sent from the list displaying module 15 (step S170). The information sent from the list displaying module 15 is information for identifying the selected email. Then, the email processing module 14 instructs the body displaying module 16 to display the body of the selected email on the email body screen 22 (step S180). Thus, the email body is displayed on the email body screen 22. Thereafter, the email processing module 14 waits (is placed on standby) until a subsequent instruction is inputted using a key and a corresponding key event comes along (step S190).

Types of Key Event

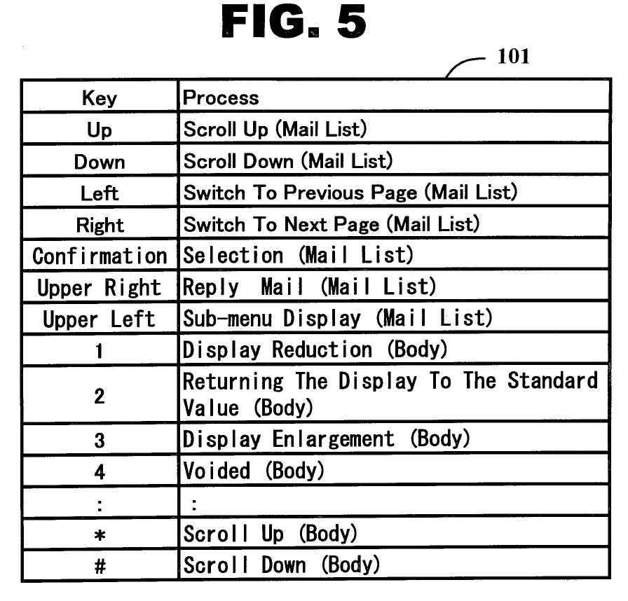

Types of key event will be described below. FIG. 5 is a table showing an example configuration of a key event assignment table. A key event assignment table 101 shown in FIG. 5 is an information table showing correspondences between keys and key events. In this embodiment, keys of the key operation module 11 are assigned to key events corresponding to the email list display and key events corresponding to the email body display. In this embodiment, the keys assigned to the key events corresponding to the email list display are different from the keys assigned to the key events corresponding to the email body display.

For example, the “up” key of the cross key (selection button) is assigned to a scroll-up process on the email list screen 21 and the “down” key thereof is assigned to a scroll-down process on the email list screen 21. The “left” key thereof is assigned to a switch-to-previous-page process on the email list screen 21 and the “right” key thereof is assigned to a switch-to-next-page process on the email list screen 21. The “confirmation” key is assigned to an item selection process (confirmation instruction) on the email list screen 21. The “upper right” key is assigned to a reply process on the email list screen 21 and the “upper left” key is assigned to a sub-menu display process on the email list screen 21.

Thus, if the “up” key, “down” key, “left” key, “right” key, “confirmation” key, “upper right” key, or “upper left” key is pressed with the email list screen 21 displayed, a key event corresponding to a scroll-up process, a scroll-down process, a switch-to-previous-page process, a switch-to-next-page process, an item selection process, a reply process, or a sub-menu display process is sent from the key operation module 11 to the email processing module 14.

Also, for example, the “1” key of the numeric keypad is assigned to a display reduction process on the email body screen 22 and the “2” key thereof is assigned to a process for returning the display to the standard size on the email body screen 22. The “3” key thereof is assigned to a display enlargement process on the email body screen 22 and the “4” key thereof or the like is assigned to an invalid key operation on the email body screen 22. The “*” key thereof is assigned to a scroll-up process on the email body screen 22 and the “#” key thereof is assigned to a scroll-down process on the email body screen 22.

Thus, if the “1” key, “2” key, “3” key, “*” key, or “#” key is pressed with the email body screen 22 displayed, a key event corresponding to a display reduction process, a process for returning the display to the standard value, a display enlargement process, a scroll-up process, or a scroll-down process is sent from the key operation module 11 to the email processing module 14.

In this embodiment, the email processing 14 determines whether the key event sent from the key operation module 11 is a key event assigned to the email list display or a key event assigned to the email body display, with reference to the key event assignment table 101.

When the user performs an key operation using the key operation module 11, the key operation module 11 sends a key event corresponding to the key operation to the email processing module 14. The email processing module 14 determines whether the key event is a key event assigned to the email list display, with reference to the key event assignment table 101 (step S200).

If the key event is a key event assigned to the email list display (YES in step S200), the email processing module 14 sends the key event (step S210) to the list displaying module 15. Each time the email processing module 14 receives a key event assigned to the email list display, it sends the key event to the list displaying module 15 (steps S200 and S210).

If the key event is not a key event assigned to the email list display (NO in step S200), the email processing module 14 determines whether the key event is a key event assigned to the email body display, with reference to the key event assignment table 101 (step S220).

If the key event is a key event assigned to the email body display (YES in step S220), the email processing module 14 sends the key event to the body displaying module 16 (step S230). Each time the email processing module 14 receives a key event assigned to the email body display, it sends the key event to the body displaying module 16 (steps S220 and S230).

Subsequently, the email processing module 14 determines whether the end of the body of the email has been displayed on the email body screen 22, according to whether the email processing module 14 has been notified that the display of the end has been detected, by the end display detection module 41 (step S240).

Once the end of the email body has been displayed on the email body screen 22 (YES in step S240), the email processing module 14 updates the confirmation status (“read” or “unread”) of the email to “read.” Specifically, the email processing module 14 causes the read/unread setting module 42 to update the status setting of the email to “read” (step S250).

If the end of the email body has not been displayed on the email body screen 22 (NO in step S240), the email processing module 14 waits until a subsequent instruction is inputted using a key and a corresponding key event comes along (step S190).

Each time the email processing module 14 receives a key event assigned to the email list display, it sends the key event to the list displaying module 15. Also, each time the email processing module 14 receives a key event assigned to the email body display, it sends the key event to the body displaying module 16. Once the end of the email body has been displayed on the email body screen 22, the email processing module 14 updates the confirmation status of the email to “read.” If the end of the email body has not been displayed on the email body screen 22, the email processing module 14 waits until a subsequent instruction is inputted using a key and a corresponding key event comes along (steps S190 to S250).

If the email processing module 14 receives a key event that is assigned to none of the email list display and email body display, it discards the key event as an invalid key event (step S260). Subsequently, the email processing module 14 waits until a subsequent instruction is inputted using a key and a corresponding key event comes along (step S190).

In FIG. 4A and FIG. 4B, first, the email processing module 14 determines whether the key event is a key event assigned to the email list display and then determines whether the key event is a key event assigned to the email body display. As another embodiment, the email processing module 14 may first determine whether a key event is a key event assigned to the email body display and then may determine whether the key event is a key event assigned to the email list display.

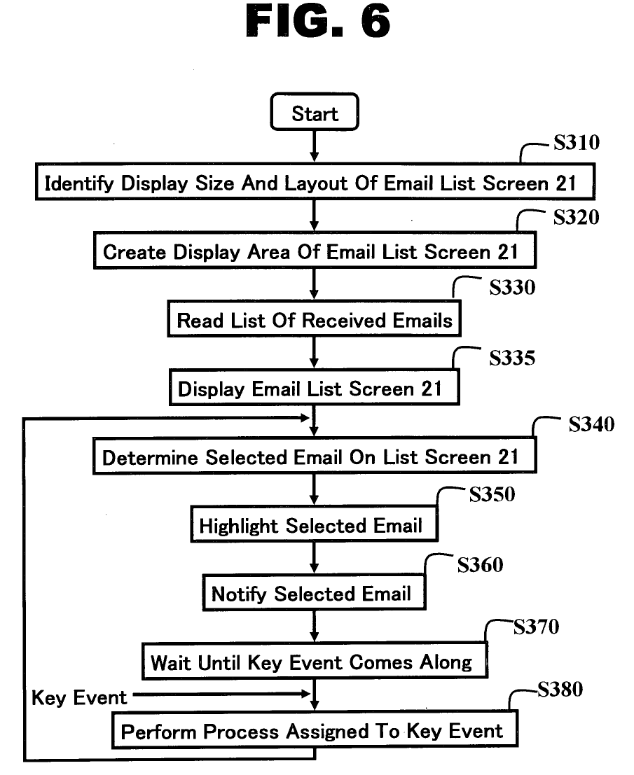

FIG. 6 is a flowchart showing operation steps of the list display processing module. When the user selects the email functions from the menu of the portable terminal 1, the portable terminal 1 starts the email functions (list displaying module 15, etc.).

The list displaying module 15 identifies the display size and layout of the email list screen 21 (step S310) sent from the email processing module 14. Then, the list displaying module 15 creates the display area (list box of received emails) of the email list screen 21 using the display size and layout (step S320). Then, the list displaying module 15 reads the list of received emails from the database 17 (step S330). Then, the list displaying module 15 stores the read email list in the received email list box and displays the list box as the email list screen 21 on the screen display module 12 (step S335).

Subsequently, the list displaying module 15 determines the selected email on the list screen 21 (step S340). If there is no instruction (instruction for specifying the selected email) inputted by the user using the key operation module 11, the list displaying module 15 determines a default received email (for example, a received email in the first row) as the selected email.

The list displaying module 15 highlights the determined selected email on the email list screen 21 (step S350) and notifies the email processing module 14 of the determined selected email (step S360). Subsequently, the list display processing module waits until a subsequent instruction is inputted using a key and a corresponding key event comes along (step S370).

If a key operation corresponding to a key event assigned to the email list display is performed, the list displaying module 15 acquires the key event from the email processing module 14. Thus, the list displaying module 15 performs (performs a process defined as a key event) a process assigned to the key event sent from the email processing module 14 (step S380). For example, the list displaying module 15 performs a scroll-up process on the email list screen 21, as a process assigned to a key event.

If another email is selected by performing the process assigned to the key event, the list displaying module 15 determines the other email as a new selected email on the email list screen 21 (step S340). Then, the list displaying module 15 highlights the determined selected email on the email list screen 21 (step S350). Also, the list displaying module 15 notifies the email processing module 14 of the determined selected email (step S360). Thereafter, the list displaying module 15 waits until a subsequent instruction is inputted using a key and a corresponding key event comes along (step S370).

Each time the list displaying module 15 receives a key event assigned to the email list display, it determines a new selected email and highlights the selected email, as well as notifies the email processing module 14 of the selected email (step S380, steps 340 to 370).

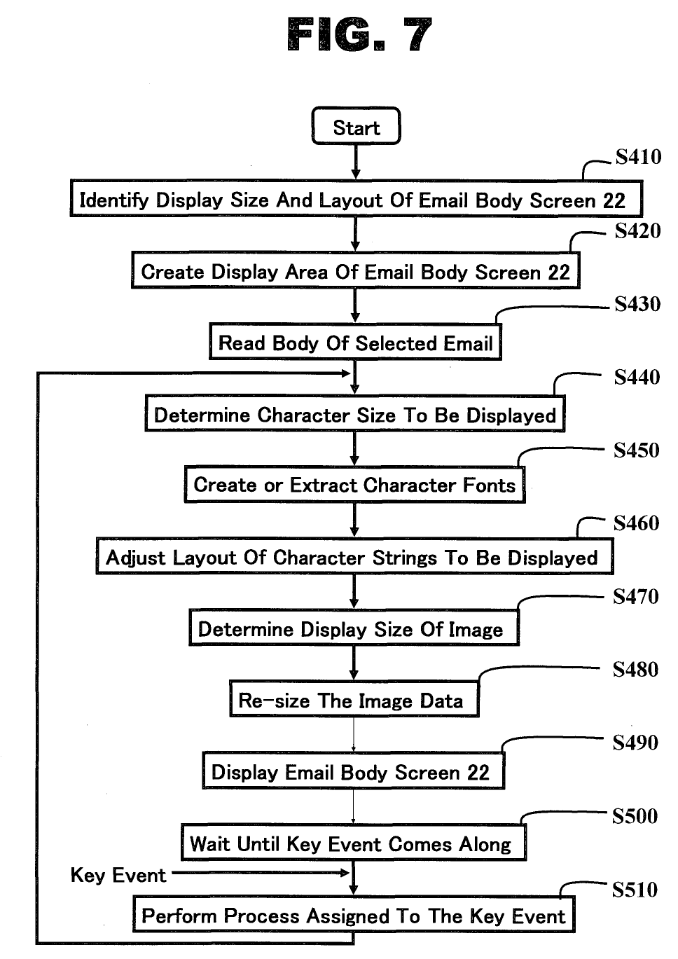

FIG. 7 is a flowchart showing operation steps of the body display processing module. When the user selects the email functions from the menu of the portable terminal 1, the portable terminal 1 starts the email functions (body displaying module 16, etc.).

The body displaying module 16 identifies the display size and layout of the email body screen 22 sent from the email processing module 14 (step S410). Then, the body displaying module 16 creates the display area of the email body screen 22 using the display and layout (step S420). Thus, the body displaying module 16 creates its own screen.

Then, the body displaying module 16 reads the body (email data) of the selected email from the database 17 (step S430). The email data includes, for example, character data and image data (image data attached to the email).

Subsequently, the body displaying module 16 determines a character size to be used when character data (character strings) is displayed on the email body screen 22 (step S440). The character size may be a predetermined default character size or a character size determined according to an instruction inputted by the user using the key operation module 11. Or, the character size may be determined according to the number of characters included in character strings, the number of images, the sizes of images, or the like. For example, if the number of characters included in character strings or the number of images is small or if the sizes of images are small, the character size of the character strings is increased. Conversely, if the number of characters included in character strings or the number of images is large or if the sizes of images are large, the character size of the character strings is reduced.

The body displaying module 16 creates a character font corresponding to the determined character size with respect to each of characters included in the character strings. The body displaying module 16 creates the character fonts of the character strings by extracting character fonts from a memory or the like storing character fonts corresponding to character sizes (step S450).

Subsequently, the body displaying module 16 adjusts the layout of character strings to be displayed as the body of the email (step S460). Specifically, the body displaying module 16 causes the character string layout control module 19A to adjust the fold-back positions (new line positions) of characters so as to display the character strings on the body displaying module 16's own screen.

If an image is included in the body of the email, the body displaying module 16 determines the display size of the image (step S470). Then, the body displaying module 16 causes the image layout control module 19B to re-size the image data (image) (step S480). Then, the body displaying module 16 displays the re-sized image on its own screen.

The size of an image to be displayed on the email body screen 22 may be a predetermined default image size or a image size determined according to an instruction inputted by the user using the key operation module 11. Or the image size may be determined according to the character size (enlargement/reduction ratio) of the email body, the number of characters, or the number of images or may be determined according to the display area of the email body screen 22 in the lateral direction. For example, if the character size of the email body is large, the image size is also increased. Or, the image size may be determined so that the lateral size of the image is included in the lateral size of the email body screen 22.

The body displaying module 16 displays the email body in the email body screen 22 by displaying the character strings of the created character fonts and the re-sized image on its own screen (step S490). Thereafter, the body displaying module 16 waits until a subsequent instruction is inputted using a key and a corresponding key event comes along (step S500).

If a key operation corresponding to a key event assigned to the email body display is performed, the body displaying module 16 acquires this key event from the email processing module 14. Then, the body displaying module 16 performs a process assigned to the key event sent from the email processing module 14 (step S510). For example, the body displaying module 16 performs a scroll-up process or a character string enlargement/reduction process on the email body screen 22 as a process assigned to the key event.

If the character size of character strings or the size of an image are changed by performing the process assigned to the key event, the body displaying module 16 determines a new character size in the email body screen 22 (step S440). Then, the body displaying module 16 creates character font corresponding to the newly determined character size with respect to each of characters included in the character strings (step S450), as well as adjusts the layout of the character strings to be displayed as the email body (step S460).

Also, the body displaying module 16 determines the display size of the image (step S470). Then, the body displaying module 16 causes the image layout control module 19B to re-size the image (step S480). Then, the body displaying module 16 displays the character strings of the created character fonts and the re-sized image on its own screen so as to display the email body in the email body screen 22 (step S490). Thereafter, the body displaying module 16 waits until a subsequent instruction is inputted using a key and a corresponding key event comes along (step S500).

Each time the body displaying module 16 receives a key event assigned to the email body display, it re-sizes the character size or image size (step S510, steps 440 to 500).

In this embodiment, when the body of an email is being displayed on the email body screen 22, the end display detection module 41 checks (detects) whether the end of the body of the email has been displayed on the email body screen 22. If the end display detection module 41 detects that the end of the email body has been displayed on the email body screen 22, the list displaying module 15 indicates on the email list screen 21 that the email is a read email.

Updating Confirmation Status of Email after Detecting End of Email Body

Operation steps to be performed when the portable terminal 1 updates the confirmation status of an email after detecting the end of the body of the email will be described in detail below. Specifically, operation steps to be performed by the portable terminal 1 when the email body is scrolled and operation steps to be performed by the portable terminal 1 when the email body is enlarged or reduced will be described.

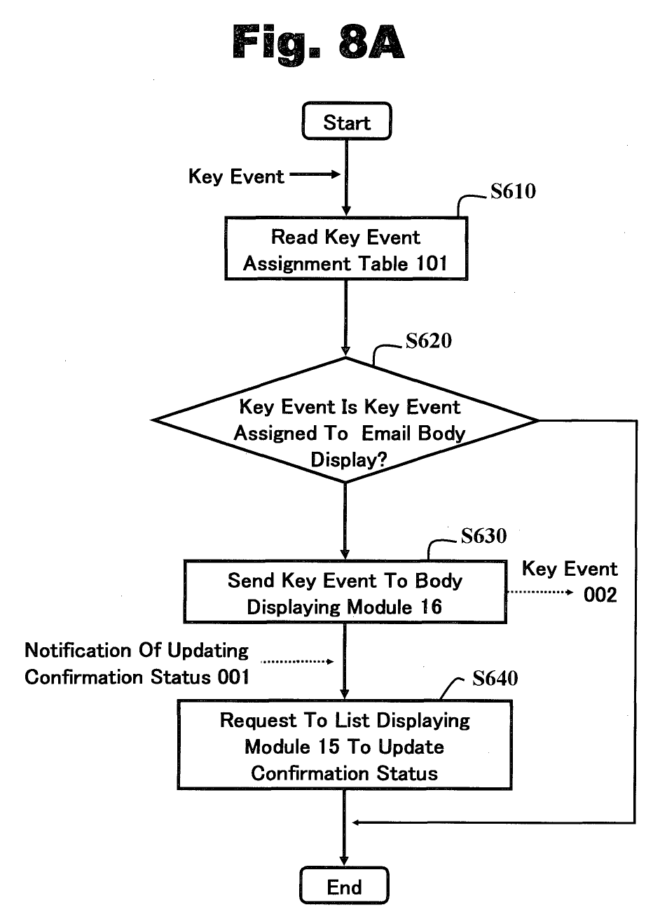

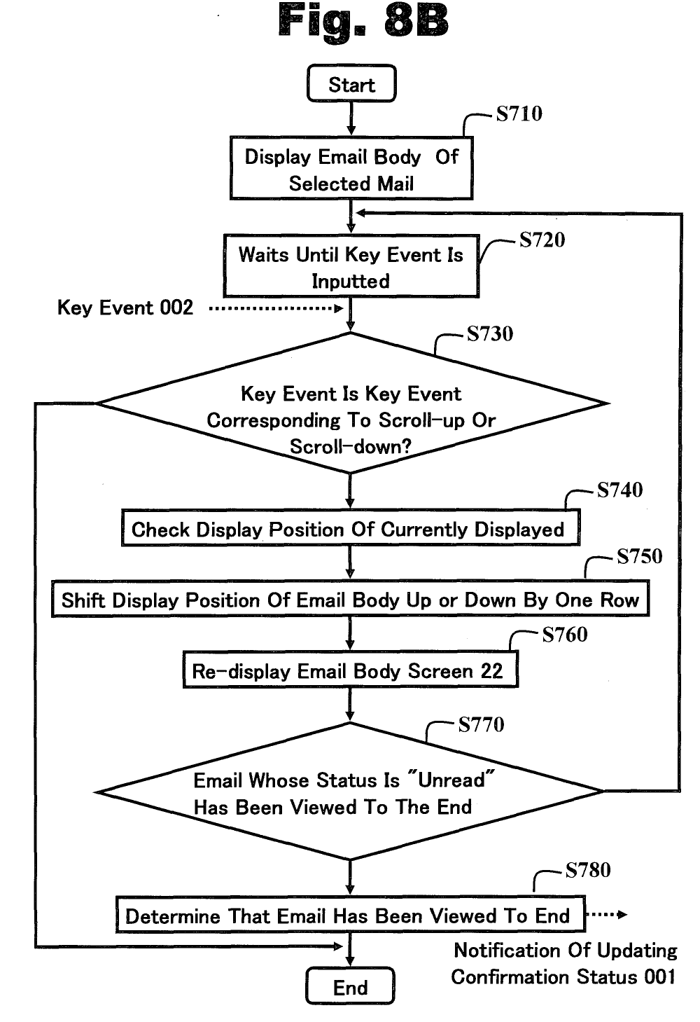

FIG. 8A and FIG. 8B are flowcharts showing operation steps to be performed by the portable terminal when the email body is scrolled. In FIG. 8A and FIG. 8B, operations identical to those described in FIGS. 4A, 4B, 6, and 7 will not be described.

Upon receipt of a key event from the key operation module 11, the email processing module 14 reads the key event assignment table 101 stored in a predetermined memory or the like (step S610). Then, the email processing module 14 determines whether the key event from the key operation module 11 is a key event assigned to the email body display, with reference to the key event assignment table 101 (step S620).

If the key event is not a key event assigned to the email body display (NO in step S620), the email processing module 14 performs a process corresponding to this key event. If the key event is a key event assigned to the email body display (YES in S620), the email processing module 14 sends the key event to the body displaying module 16 (step S630) These processes performed by the email processing module 14 in steps S620 and S630 are the same as those performed in steps S220 and S230 shown in FIG. 4A and FIG. 4B.

The body displaying module 16 displays the email body on the email body screen 22 according to an instruction from the email processing module 14 (step S710). Then, the body displaying module 16 displays the email body screen 22 on the screen display module 12 and then waits until a subsequent key event is inputted (step S720). These processes performed by the body displaying module 16 in steps S710 and S720 are the same as those performed in steps S490 and S500 shown in FIG. 7.

Upon receipt of the key event assigned to the email body display from the email processing module 14, the body displaying module 16 determines to which process this key event corresponds (step S730).

If the key event from the email processing module 14 is a key event corresponding to a scroll-up or a scroll-down (YES in step S730), the body displaying module 16 scrolls the displayed email body. Specifically, first, the body displaying module 16 examines (checks) the display position of the currently displayed email body (step S740).

If the key event is a key event corresponding to a scroll-up and if the top of the display is not the top of the email body, the body displaying module 16 determines that the email body screen 22 can be scrolled up. Thus, the body displaying module 16 re-displays (updates) the email body screen 22 by shifting the display position (display position information) of the email body upward by one row.

If the key event is a key event corresponding to a scroll-down and if the bottom of the display is not the end of the email body, the body displaying module 16 determines that the email body screen 22 can be scrolled down. Thus, the body displaying module 16 re-displays (updates) the email body screen 22 by shifting the display position (display position information) of the email body downward by one row (steps S750 and S760). By performing the scroll-up and scroll-down processes on the email body in these ways, the contents of the email body are updated.

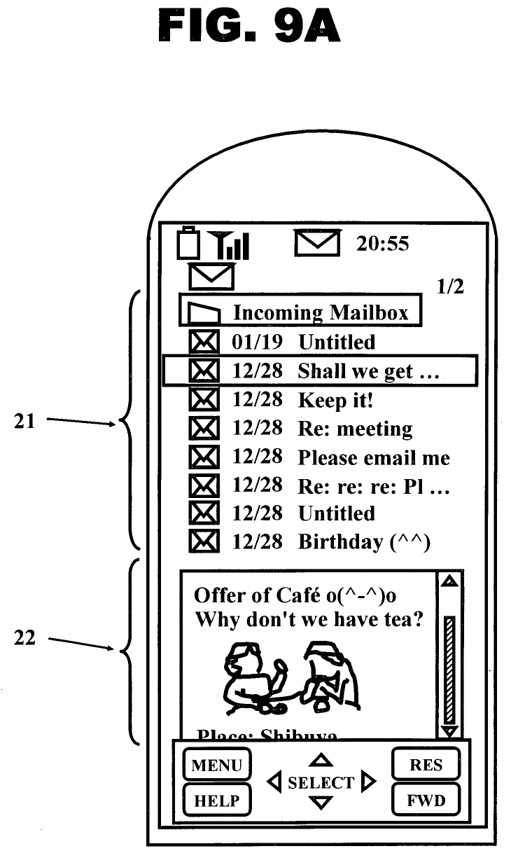

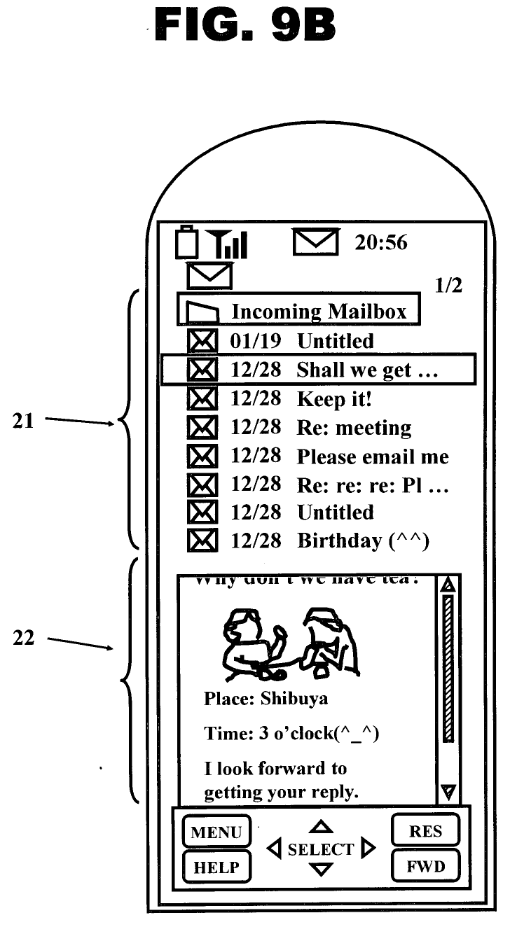

FIG. 9A and FIG. 9B are drawings showing a process in which the end of the body of an email is displayed by scrolling the email body. As shown in FIG. 9A and FIG. 9B, if a key event corresponding to a scroll-down is generated as a key event assigned to the email body display with the email list screen 21 and email body screen 22 displayed simultaneously, the body displaying module 16 shifts the display position of the email body downward (toward the end of the email body) on the email body screen 22. If a key event corresponding to a scroll-down is generated a required number of times, the end of the email body is displayed.

When the email body is being displayed on the email body screen 22, the end display detection module 41 checks whether the end of the email body has been displayed on the email body screen 22 (step S770). If the displayed selected email, whose status is “unread”, is scrolled down and thus the end of the character strings in the email body becomes the bottom of the display (YES in step S770), the end display detection module 41 determines that the email has been viewed to the end. Then, the end display detection module 41 notifies the read/unread setting module 42 that the end of the email body has been displayed (step S780).

If the end of the character strings in the email body has not become the bottom of the display (NO in step S770), the end display detection module 41 determines that the email has not been viewed to the end. Thereafter, the body displaying module 16 waits until a subsequent key is inputted (step S720).

Subsequently, when a key event assigned to the email body display is sent from the email processing module 14 to the body displaying module 16, the body displaying module 16 determines to which process this key event corresponds (step S730).

If the key event from the email processing module 14 is not a key event corresponding to a scroll-up or scroll-down (NO in step S730), the body displaying module 16 performs a process corresponding to this key event. Each time the body displaying module 16 receives a key event assigned to the email body display, the body displaying module 16 performs the processes performed in steps S730 to S770 and S720.

Upon receipt of notification that the end of the body of an email has been displayed from the end display detection module 41, the read/unread setting module 42 updates the confirmation status of the email from “unread” to “read” in the database 17. Then, the read/unread setting module 42 notifies the email processing module 14 that the confirmation status has been updated (updated from “unread” to “read”).

Upon receipt of the notification that the confirmation status has been updated, the email processing module 14 requests the list displaying module 15 to update the email list screen 21 (step S640). Then, the list displaying module 15 reads data corresponding to the currently displayed email list from the database 17, and then updates the currently displayed email list screen 21. Thus, The portable terminal 1 indicates on the email list screen 21 that the received email, whose body's end has been displayed, is a read email. A mark or the like indicating that the received email is a read email is displayed, for example, next to the reception date or title of the received email on the email list screen 21.

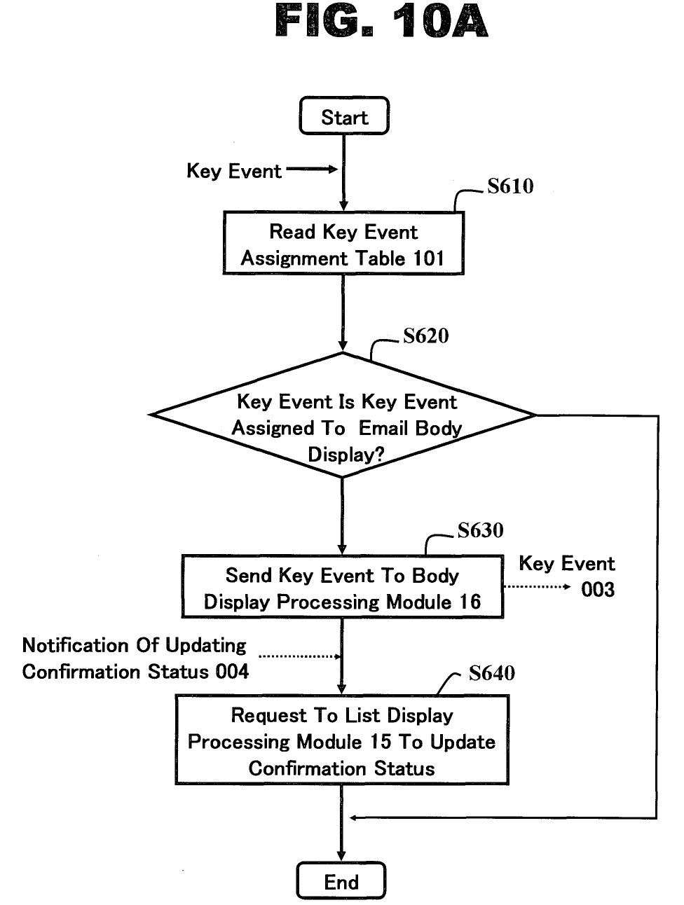

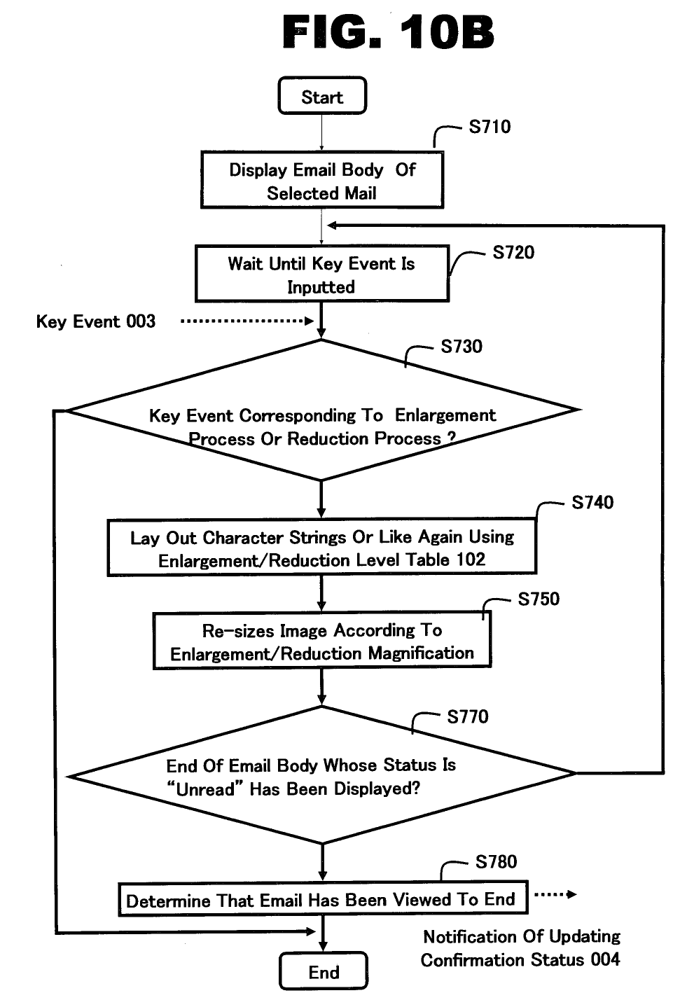

FIG. 10A and FIG. 10B are flowcharts showing operation steps to be performed by the portable terminal when the body of an email is enlarged or reduced. In FIG. 10A and FIG. 10B, processes identical to those described in FIGS. 4A, 4B, 6, 7, 8A, and 8B will not be described.

Upon receipt of a key event from the key operation module 11, the email processing module 14 determines whether the key event is a key event assigned to the email body display, according to the key event assignment table 101 (steps S610 and S620). If the key event is a key event assigned to the email body display (YES in step S620), the email processing module 14 sends the key event to the body displaying module 16 (step S630).

The body displaying module 16 displays the email body on the email body screen 22 according to an instruction from the email processing module 14 (step S810). Thereafter, the body displaying module 16 waits until a subsequent key event is inputted (step S820).

Upon receipt of the key event assigned to the email body display from the email processing module 14, the body displaying module 16 determines to which process this key event corresponds (step S830).

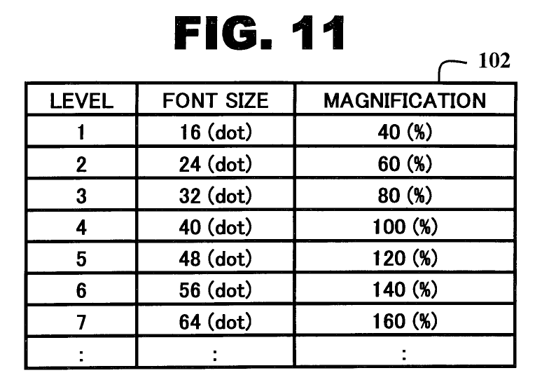

If the key event from the email processing module 14 is a key event corresponding to an enlargement process or a reduction process (YES in step S830), the body displaying module 16 enlarges or reduces the currently displayed email body. At that time, the body displaying module 16 lays out the character strings or the like again using an enlargement/reduction level table 102 shown in FIG. 11 (step S840). Specifically, first, the body displaying module 16 lowers or raises the level (display magnification) of enlargement or reduction of the currently displayed email body by only one level. Then, the body displaying module 16 creates the font size of characters to be displayed subsequently, as well as calculates the number of characters displayable in one row using the created font size.

FIG. 11 is a table showing an example configuration of an enlargement/reduction level table. The enlargement/reduction level table 102 shown in FIG. 11 is information table in which levels, font sizes, and magnifications are associated with one another.

For example, email bodies (character strings) having levels “1,” “2,” and “3,” have font sizes of 16 dots, 24 dots, and 32 dots and magnifications (display magnifications) of 40%, 60%, and 80%, respectively.

Also, email bodies (character strings) having levels “4,” “5,” “6,” and “7” have font sizes of 40 dots, 48 dots, 56 dots, and 64 dots and magnifications (display magnifications) of 100%, 120%, 140%, and 160%, respectively.

Subsequently, the body displaying module 16 updates the setting of the number of characters displayable in one row with respect to the character strings in the currently displayed email body and causes the character string layout control module 19A to automatically adjust the fold-back positions of characters. Also, the body displaying module 16 causes the image layout control module 19B to re-size the image. The image layout control module 19B re-sizes the image according to an enlargement/reduction magnification (size of character string) corresponding to a new level (step S850). Then, the image layout control module 19B re-sets the display layout of the entire email body to update the email body screen 22. By performing an enlargement process or a reduction process on the email body in this way, the contents of the email body are updated in real time.

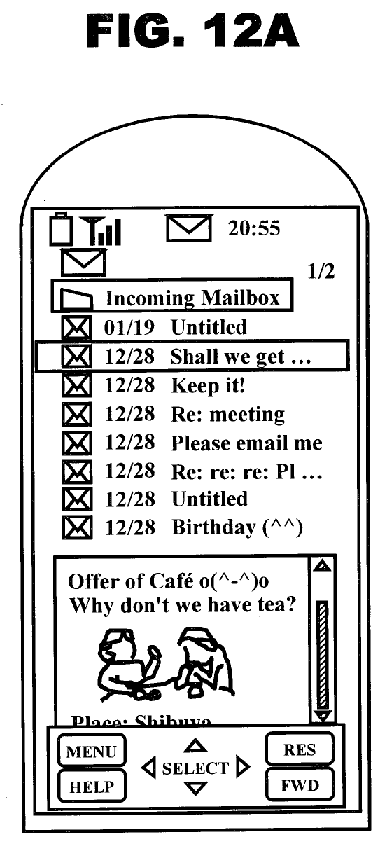

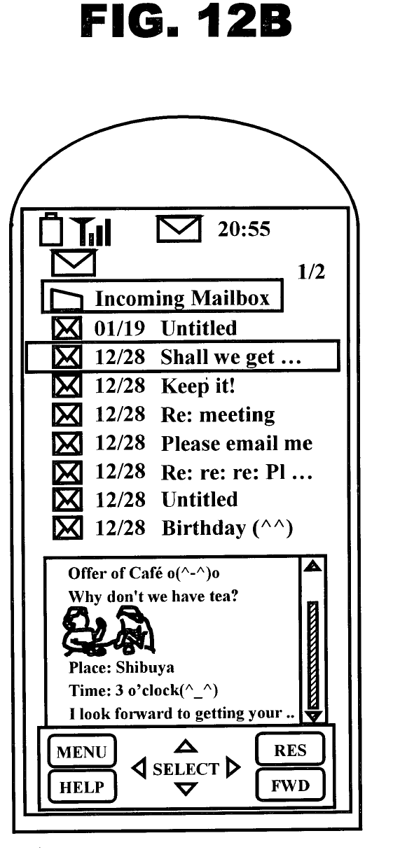

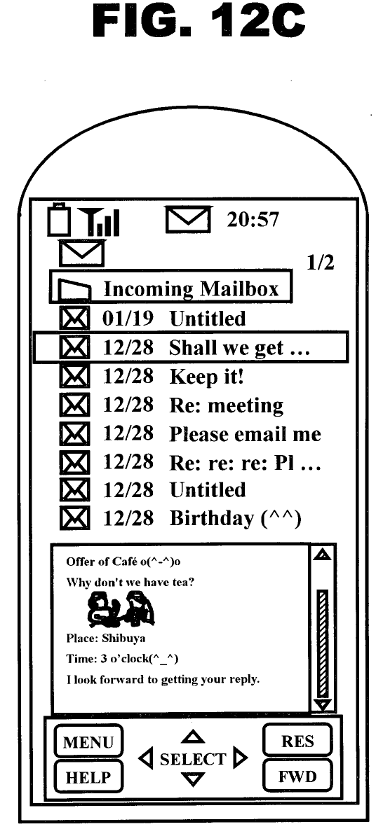

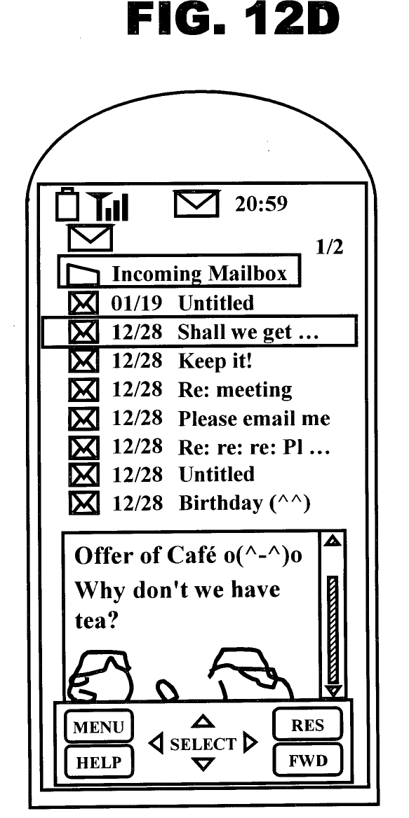

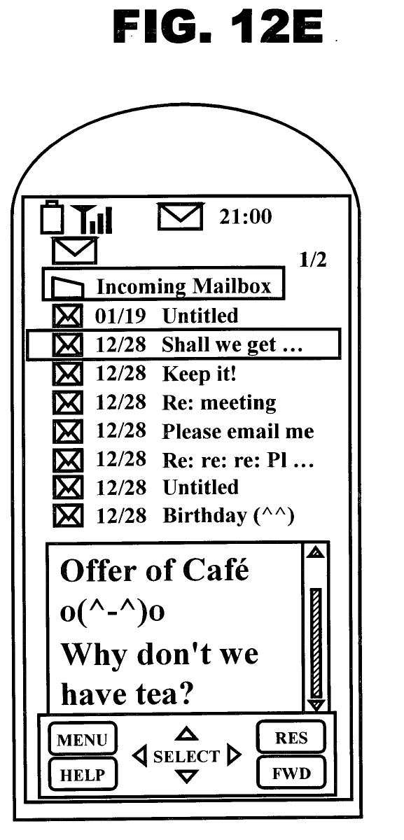

FIG. 12A, FIG. 12B, FIG. 12C, FIG. 12D, and FIG. 12E are drawings showing an email body enlargement process and an email body reduction process. As shown in FIG. 12A, if a key event corresponding to a reduction process is generated as a key event assigned to the email body display, the email body is reduced (FIG. 12B). If a key event corresponding to another reduction process is generated in this state, the email body is further reduced (FIG. 12C). In this embodiment, by repeating a reduction process, the end of the email body may be displayed.

If a key event corresponding to an enlargement process is generated as a key event assigned to the email body display, the email body is enlarged (FIG. 12D). If a key event corresponding to another enlargement process is generated in this state, the email body is further enlarged (FIG. 12E).

When the email body is being displayed on the email body screen 22, the end display detection module 41 checks whether the end of the email body has been displayed on the email body screen 22 (step S860). If the body of the displayed selected email, whose status is “unread”, is reduced and thus the end of the character strings in the email body is displayed (YES in step S860), the end display detection module 41 determines that the email has been viewed to the end. Then, the end display detection module 41 notifies the read/unread setting module 42 that the end of the email body has been displayed (step S870).

If the end of the character strings in the email body has not become the bottom of the display (NO in step S870), the end display detection module 41 determines that the email has not been viewed to the end. Thereafter, the body displaying module 16 waits until a subsequent key is inputted (step S820).

Subsequently, when the body displaying module 16 receives a key event assigned to the email body display from the email processing module 14, it determines to which process this key event corresponds (step S830).

If the key event from the email processing module 14 is not a key event corresponding to an enlargement process or a reduction process (NO in step S830), the body displaying module 16 performs a process corresponding to this key event. Each time the body displaying module 16 receives a key event assigned to the email body display, it performs the processes performed in steps S830 to S860, and S820).

Upon receipt of notification that the end of the body of an email has been displayed from the end display detection module 41, the read/unread setting module 42 updates the confirmation status of the email from “unread” to “read” in the database 17. Then, the read/unread setting module 42 notifies the email processing module 14 that the confirmation status has been updated (updated from “unread” to “read”).

Upon receipt of the notification that the confirmation status has been updated, the email processing module 14 requests the list displaying module 15 to update the email list screen 21 (step S640). The list displaying module 15 reads data corresponding to the currently displayed email list from the database 17, and then updates the currently displayed email list screen 21. Thus, The portable terminal 1 indicates on the email list screen 21 that the received email, whose body's end has been displayed, is a read email.

In this embodiment, a case has been described where the email list screen 21 is displayed in the upper half of the display screen and the email body screen 22 is displayed in the lower half thereof; however, the display areas of the email list screen 21 and email body screen 22 may be of any size (ratio).

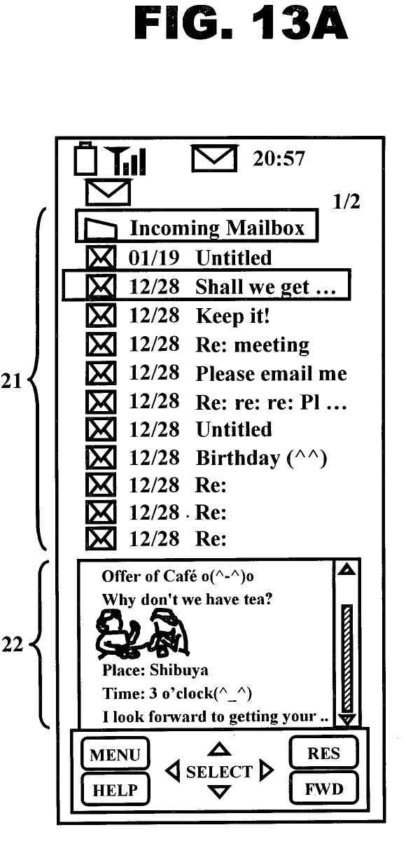

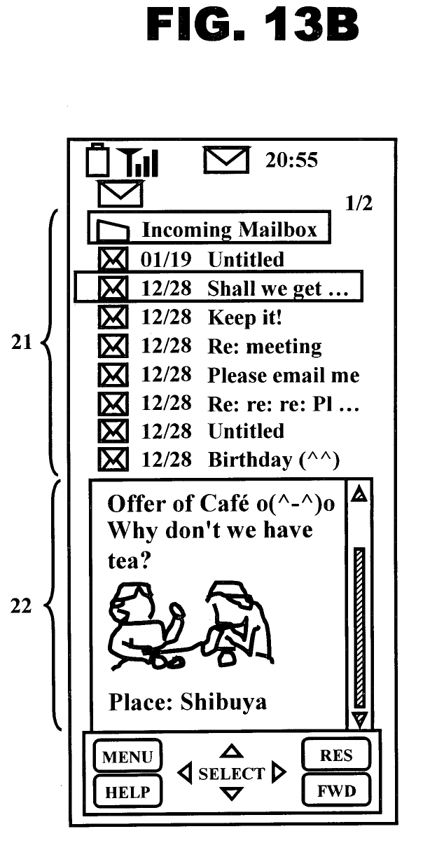

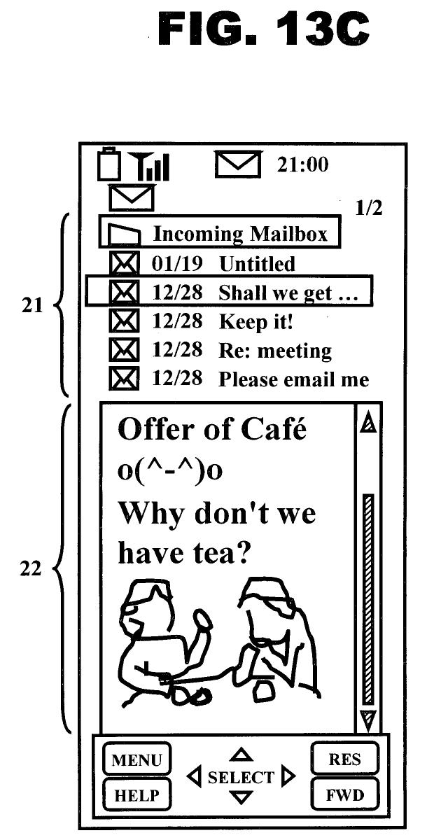

Or, the sizes of the display areas of the email list screen 21 and email body screen 22 may be changed according to the display states of the email list screen 21 and email body screen 22. FIG. 13A, FIG. 13B, and FIG. 13C are drawings showing the sizes of the display areas of the email list screen and email body screen.

For example, if the email body is reduced on the email body screen 22, the display area of the email body screen 22 is made smaller than that in a normal case (FIG. 13B). On the other hand, the display area of the email list screen 21 is made larger than that in the normal case FIG. 13B (FIG. 13A).

If the email body is enlarged on the email body screen 22, the display area of the email body screen 22 is made larger than that in the normal case FIG. 13B. On the other hand, the display area of the email list screen 21 is made smaller than that in the normal case FIG. 13B (FIG. 13C).

In this case, the sizes of the display areas of the email body screen 22 and email list screen 21 may be determined according to the enlargement ratio or reduction ratio of the email body. Specifically, the display area of the email body screen 22 is increased as the enlargement ratio of the email body is increased, while the display area of the email body screen 22 is reduced as the reduction ratio of the email body is increased.

Thus, a display area that is no longer used due to the reduced display of the email body is used as a display area of the email list screen 21. This allows effective use of the display area. Also, a part of the email body that is prevented from being displayed due to the enlarged display of the email body is displayed on the email body screen 22 that has become wider than it normally is. This allows effective use of the display area.

Or, the sizes of the display areas of the email body screen 22 and email list screen 21 may be determined according to the overall size (size on the email body screen 22) of the email body, whose display aspect has been changed. Specifically, if the number of characters or the number of images in the email body is large or if the character size or image size in the email body is large, the display area of the email body screen 22 is increased. Conversely, if the number of characters or the number of images in the email body is small or if the character size or image size in the email body is small, the display area of the email body screen 22 is reduced. Thus, if the overall size of the email body is large, the email body is displayed in an easy-to-see manner. If the overall size of the email body is small, the email list is displayed in an easy-to-see manner.

Incidentally, if the email body is reduced on the email body screen 22, the display area of the email body screen 22 may be made wider than it normally is. In this case, the display area of the email list screen 21 is made smaller than it normally is.

Also, if the email body is enlarged on the email body screen 22, the display area of the email list screen 21 may be made wider than it normally is. In this case, the display area of the email body screen 22 is made smaller than it normally is.

Also in this case, the sizes of the display areas of the email body screen 22 and email list screen 21 may be determined according to the enlargement ratio or reduction ratio of the email body. Specifically, the display area of the email body screen 22 is reduced as the enlargement ratio of the email body is increased, while the display area of the email body screen 22 is increased as the reduction ratio of the email body is increased.

Thus, if the email body is reduced, a larger number of characters or images are displayed as the email body. Conversely, if the email body is enlarged, a list of a larger number of emails is displayed. This allows effective use of the display area.

Also, the display aspect on the email list screen 21, such as the size (enlargement ratio or reduction ratio) of characters or images, may be changed according to the size of characters or images on the email body screen 22. For example, characters or images on the email list screen 21 may be displayed in a size identical to that in the email body screen 22. Thus, an instruction sent from the user to the email body screen 22 is easily reflected on the email list screen 21. As a result, the user is allowed to change the size of characters or images displayed on the email body screen 22 and email list screen 21 with fewer operations.

In this embodiment, a case has been described where the end display detection module 41 determines that a received email has been viewed to the end when the end of the body of the email has been displayed; however, the end display detection module 41 may determine that the received email has been viewed to the end when the end of the email body has been displayed over a predetermined time period.

Thus, even if the body of a received email has been displayed due to a misoperation of the portable terminal 1, the email is handled as an unread email as long as the time period when the email has been displayed is short.

In this embodiment, a case has been described where the email list screen 21 and email body screen 22 are displayed in a portrait screen; however, the email list screen 21 and email body screen 22 may be displayed in a landscape screen.

In this embodiment, a case has been described where the email list screen 21 or email body screen 22 is scrolled up or down; however, the email list screen 21 or email body screen 22 may be scrolled to the right or to the left. Also in this case, if the displayed selected email, whose status is “unread,” is scrolled to the right and thus the end of character strings in the email body is displayed, the email is displayed as a read email.

In this embodiment, a case has been described where the list of emails is displayed on the email list screen 21 in such a manner that each received email is displayed using one row; however, each received email may be displayed using two or more rows.

If each received email is displayed using two or more rows, the display area of the email list screen 21 may be made larger than it normally is. In this case, the display area of the email body screen 22 may be made smaller than it normally is.

In this case, the sizes of the display areas of the email list screen 21 and email body screen 22 may be determined according to the number of rows of the email list. Specifically, the display area of the email list screen 21 is increased as the number of rows of the email list is increased. Thus, if the number of rows of the email list is large, the email list is displayed in an easy-to-see manner. Conversely, if the number of rows of the email list is small, the email body is displayed in an easy-to-see manner.

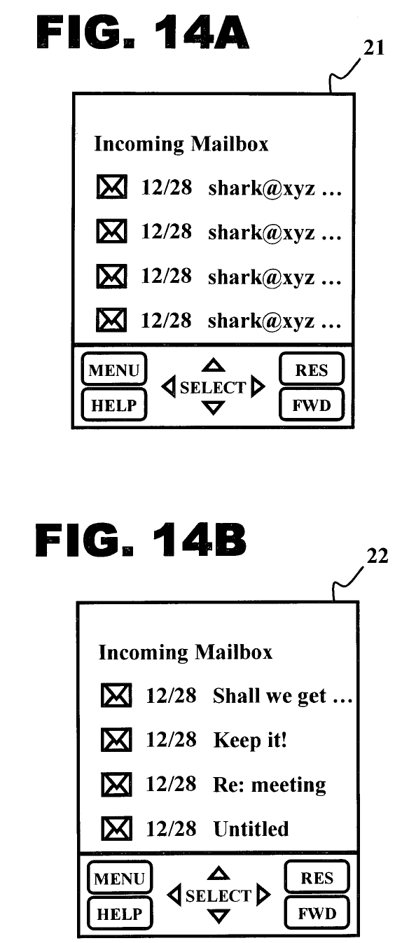

In this embodiment, a case has been described where the title of each received email is displayed when the email list is displayed on the email list screen 21 as shown in FIG. 14B; however, the sender (destination, etc.) or sender (name, etc.) of each received email may be displayed as shown in FIG. 14A. Or, the display of each received email may be switchable.

In this embodiment, a case has been described where the email list screen 21 is disposed on the upper side of the display screen and the email body screen 22 is disposed on the lower side thereof; however, the email list screen 21 and email body screen 22 may be disposed in any positions.

In this embodiment, different keys are assigned to the email body display and email list display; however, identical keys may be assigned to these displays. In this case, first, an operation for specifying either of the email body display and email list display is performed, and then an operation related to the email body display or email list display is performed.

In this embodiment, a case has been described where the portable terminal 1 is a cell phone; however, the portable terminal 1 is applicable to any apparatus having email functions. For example, the portable terminal 1 may be a personal handyphone system (PHS) or a personal digital assistant (PDA), a car navigation system, or a game machine.

In this embodiment, a case has been described where the selected email is specified in the email list using the cross key or the like; however, the selected email may be specified in the email list using a mouse. Even if the selected email is specified in the email list using a mouse, the confirmation status of a received email is changed from “unread” to “read” according to whether the end of the body of the email has been displayed. Thus, even if the body of a received email is displayed due to a misoperation of the portable terminal 1, the email is handled as an unread email unless the end of the email body is displayed.

As described above, according to this embodiment, the confirmation status of a received email is changed from “unread” to “read” according to whether the end of the body of the email has been displayed. Therefore, the portable terminal 1 properly determines whether each received email is an email that has actually been viewed or an email that has been just passed through on the email list screen so as to properly indicate whether each received email is a read email or an unread email.

Also, according to this embodiment, the email list screen 21 and email body screen 22 are displayed simultaneously and keys other than keys assigned to processes related to the email list display are assigned to processes, (scroll-up, scroll-down, enlargement, reduction, etc.) related to the email body display. Thus, if an attempt is made to display the body of a received email displayed on the email list, it is sufficient to perform a key operation for selecting the received email. Therefore, after selecting the received email, there is no need to perform a key operation (a press of the selection confirmation button) for confirming the selection. As a result, the entire email body is displayed with fewer operations while displaying both the email list and email body.

Among the processes described in this embodiment, all or part of processes described as processes to be performed automatically may be performed manually. Also, all or part of processes described as processes to be performed manually may be performed automatically using a known method. Further, the process steps, control steps, specific names, and information, including various types of data and parameters, described in this specification or shown in the drawings may be arbitrarily changed unless otherwise specified.

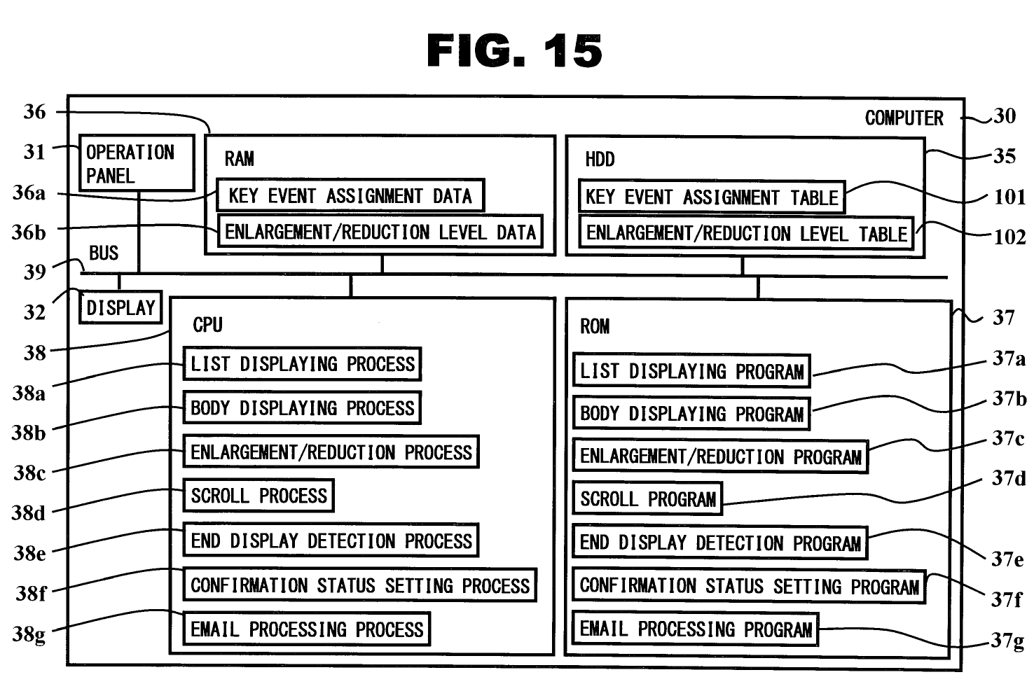

The components of the portable terminal 1 shown in FIG. 3 represent functional concepts and need not always be physically configured as shown in FIG. 3. The specific configuration of distribution or integration of the components is not limited to that shown in FIG. 3 and all or part of the components may be distributed or integrated functionally or physically according to various kinds of loads, usage situation, or the like. All or part of the processing functions of the components are performed by a central processing unit (CPU) and a program analysis-executed by the CPU or performed by hardware in which wired logic is used. Therefore, the variety of processes described in the above-described embodiment are performed by executing a previously prepared program using a computer. Hereafter, an example of a computer for executing an email display program having the same functions as those in the above-described embodiment will be described with reference to FIG. 15. FIG. 15 is a diagram showing a computer for executing an email display program.

As shown in FIG. 15, a computer 30 serving as an email apparatus includes an operation panel 31, a display 32, an HDD 35, a RAM 36, a ROM 37, and a CPU 38, which are coupled to one another via a bus 39. Here, the operation panel 31 corresponds to the key operation module 11 shown in FIG. 3 and the display 32 corresponds to the screen display module 12 shown in FIG. 3.

The ROM 37 previously stores an email display program for performing the same functions as those in the above-described embodiment, specifically, a list displaying program 37a, a body displaying program 37b, an enlargement/reduction program 37c, a scroll program 37d, an end display detection program 37e, a confirmation status setting program 37f, and an email processing program 37g, as shown in FIG. 15. As with the components of the portable terminal 1 shown in FIG. 3, the programs 37a to 37g may be integrated or distributed as appropriate.

The CPU 38 reads the programs 37a to 37g from the ROM 37 and executes the programs. Thus, as shown in FIG. 15, the programs 37a to 37g function as a list displaying process 38a, a body displaying process 38b, an enlargement/reduction process 38c, a scroll process 38d, an end display detection process 38e, a confirmation status setting process 38f, and an email processing process 38g, respectively. The processes 38a to 38g correspond to the list displaying module 15, body displaying module 16, scaling control module 18, scroll functions of the list displaying module 15 and body displaying module 16, end display detection module 41, read/unread setting module 42, and email processing module 14, respectively, shown in FIG. 3. The CPU 38 functions as modules that execute each process.

As shown in FIG. 15, the HDD 35 stores the key event assignment table 101 and enlargement/reduction level table 102. The CPU 38 reads the key event assignment table 101 or enlargement/reduction level table 102 from the HDD 35 and stores these tables in RAM 36. Then, the CPU 38 identifies a key event or performs an enlargement/reduction process or the like according to the key event assignment table 101 or enlargement/reduction level table 102 stored in RAM 36 as a key event assignment data 36a or an enlargement/reduction level data 36b.

The above-described programs 37a to 37g need not always be stored in the ROM 37 in advance. For example, the programs 37a to 37g may be previously stored in a “transportable physical medium” insertable into the computer, such as a flexible disk (FD), a compact disc-read-only memory (CD-ROM), a magneto-optical (MO) disk, a digital versatile disc (DVD), an optical magnetic disk, or an integrated circuit (IC) card, a “fixed physical medium” provided inside or outside the computer 30, such as a hard disk drive (HDD), or “another computer (or server)” connected to the computer 30 via a public line, the Internet, a local area network (LAN), or a wide area network (WAN), and then the computer 30 may read the programs from these media or computer to execute the programs.

As is understood from the above description, the portable terminal according to this embodiment is suitable for displaying received emails.

A portable terminal according to the above-described embodiment sends or receives an email and displays information on a received email. The portable terminal includes a display module for displaying a body of the received email on a display screen, an end detection module for detecting whether an end of the body has been displayed on the display screen, and a read/unread management module for managing a read/unread status indicating whether the received email is a read email or an unread email and, if the end detection module detects that the end of the body has been displayed on the display screen, managing the read/unread status of the received email, whose body's end has been displayed, as a read status.

According to the portable terminal according to the embodiment, if the end of the body is displayed on the display screen, the read/unread status of the received email is managed as a read status. As a result, whether the received email is a read email or an unread email is properly indicated.

Also, in the portable terminal according to the above-described embodiment, the display module displays a list of the received email on the display screen and, when the display module displays the list of the received email on the display screen, the read/unread management module displays information indicating the read/unread status in such a manner that the information is associated with each of the received email.

According to the portable terminal, if the list of the received email is displayed, the read/unread status is displayed in such a manner that the read/unread status is associated with each received email. As a result, whether each received email is a read email or an unread email is easily indicated.

Also, in the portable terminal according to the above-described embodiment, if the end of the body has been displayed on the display screen over a predetermined time period, the end detection module detects that the end of the body has been displayed on the display screen.

According to the portable terminal, if the end of the body has been displayed on the display screen over a predetermined time period, it is detected that the end of the body has been displayed. Therefore, even if the body of an email has been displayed due to a misoperation, the email is managed as an unread email as long as the time period during which the body has been displayed is shorter than the predetermined time period. As a result, whether each received email is a read email or an unread email is properly indicated.

A portable terminal according to the above-described embodiment sends or receives an email and displays information on a received email. The portable terminal includes a display module for displaying a body of a received email and a list of received emails simultaneously as a body display screen and a list display screen, respectively, a key operation module for receiving input of an instruction related to display of a received email using a key, and a display aspect control module for, if an instruction for changing a display aspect of the body is inputted to the key operation module using a key when the display module is displaying the body display screen and the list display screen simultaneously, controlling the display module so that the display aspect of the body is changed according to the instruction inputted to the key operation module using a key.

According to the portable terminal, the display aspect of the body of a received email is changed according to an instruction inputted using a key with both the email body and the received email list displayed. As a result, the body is easily displayed while changing the display aspect of the body with less operations.

Also, in this portable terminal, an instruction for changing the display aspect of the body and an instruction for specifying a received email, the body of which is to be displayed, in the list are assigned to different keys of the key operation module.

According to the portable terminal, an instruction for changing the display aspect of the body and an instruction for specifying a received email, the body of which is to be displayed, in the list are assigned to different keys. As a result, the change of the display aspect of the body and the specification of a received email, the body of which is to be displayed, are easily performed with fewer operations.

Also, in this portable terminal, the display aspect control module controls the display module so that the display aspect of the list is changed to a display aspect according to the display aspect of the body.

Also, in this portable terminal, the display aspect control module determines display areas of the body display screen and list display screen according to an instruction for changing the display aspect of the body inputted to the key operation module using a key and causes the display module to display the display areas of the body display screen and list display screen according to the determined display areas.

According to the portable terminal, the display aspect of the list is changed to a display aspect according to the display aspect of the body. As a result, an instruction related to the display of the body is also easily reflected on the list.

Also, in this portable terminal, the display aspect control module determines the display areas of the body display screen and list display screen according to the display size of the entire body on the display screen after the display aspect of the body is changed.

Also, in this portable terminal, the instruction for changing the display aspect of the body is at least one of an instruction for displaying the body, an instruction for reducing the body, and an instruction for scrolling the body.

The above-described embodiment also relates to a recording medium storing a program for causing a computer to perform an email display method for sending or receiving an email and displaying information on a received email. The program causes the computer to perform: a display step of displaying a body of the received email on a display screen; an end detection step of detecting whether an end of the body has been displayed on the display screen; and a read/unread management step of, upon detecting that the end of the body has been displayed on the display screen, managing a read/unread status indicating whether the received email, whose body's end has been displayed, is a read email or an unread email, as a read status.

Also, in this program, in the display step, a list of the received email is displayed on the display screen, and in the read/unread management step, information indicating the read/unread status is displayed on the display screen in such a manner that the information is associated with each of the received email.

Also, in this program, in the end detection step, if the end of the body has been displayed on the display screen over a predetermined time period, it is detected that the end of the body has been displayed on the display screen.

The above-described embodiment also relates to a recording medium storing a program for causing a computer to perform an email display method for sending or receiving an email and displaying information on a received email. The program causes the computer to perform: a simultaneous display step of displaying a list of the received email and a body of the received email selected in the list simultaneously as a list display screen and a body display screen, respectively; a key operation step of receiving input of an instruction related to display of the receive email using a key; and a display aspect control step of, if an instruction for changing a display aspect of the body is inputted using a key with the body display screen and the list display screen displayed simultaneously, performing control such that the display aspect of the body is changed according to the instruction inputted using the key.

The above-described embodiment also relates to a method for sending or receiving an email and displaying information on a received email. The method includes a display step of displaying a body of the received email on a display screen; an end detection step of detecting whether an end of the body has been displayed on the display screen; and a read/unread management step of, upon detecting that the end of the body has been displayed on the display screen, managing a read/unread status indicating whether the received email, whose body’ end has been displayed, is a read email or an unread email, as a read status.

The above-described embodiment also relates to a control circuit for use in a portable terminal for sending or receiving an email and displaying information on a received email. The control circuit includes a display module for displaying a body of the received email on a display screen, an end detection module for detecting whether an end of the body has been displayed on the display screen, and a read/unread management module for managing a read/unread status indicating whether the received email is a read email or an unread email and, if the end detection module detects that the end of the body has been displayed on the display screen, managing the read/unread status of the received email, whose body's end has been displayed, as a read status.

The above-described embodiment also relates to a control circuit for use in a portable terminal for sending or receiving an email and displaying information on a received email. The control circuit includes a display module for displaying a list of the received email and a body of the received email selected in the list simultaneously as a list display screen and a body display screen, respectively, a key operation module for receiving input of an instruction related to display of the received email using a key, and a display aspect control module for, if an instruction for changing a display aspect of the body is inputted to the key operation module using a key when the display module is displaying the body display screen and the list display screen simultaneously, controlling the display module so that the display aspect of the body is changed according to the instruction inputted to the key operation module.

An advantage of the invention to provide a portable terminal that properly indicates whether each received email is a read email or an unread email.

According to an aspect of the invention, a portable terminal for sending or receiving an email and displaying information on a received email includes: a display module for displaying a body of the received email on a display screen; an end detection module for detecting whether an end of the body has been displayed on the display screen; and a read/unread management module for managing a read/unread status indicating whether the received email is a read email or an unread email and, if the end detection module detects that the end of the body has been displayed on the display screen, managing the read/unread status of the received email, whose body's end has been displayed, as a read status.

According to the portable terminal according to the aspect of the invention, if the end of the body is displayed on the display screen, the read/unread status of the received email is managed as a read status. As a result, whether the received email is a read email or an unread email is properly indicated.

What is claimed is:

1. A portable terminal having a display screen for displaying a plurality of emails on the display screen, the portable terminal comprising:
a receiving module for receiving a plurality of emails each having a body;
a first display processing module for displaying the body of the email on the display screen;
a detector for detecting the last of the body displayed on the display screen; and
a second display processing module for displaying on the display screen a list of the plurality of the emails and status of each of the emails indicating whether the last of the body of each of the emails has been displayed.

2. The portable terminal according to claim 1, wherein the detector detects the last of the body to be displayed on the display screen when the last of the body is displayed on the display screen longer than a predetermined period.

3. The portable terminal according to claim 1, wherein the first display processing module for displaying the body of the email and the second display processing module for displaying the list of the plurality of the emails on the display screen at the same time.

4. The portable terminal according to claim 1, further comprising a scaling control module for determining an area of the display screen of the body and an area of the display screen of the list by changing of the form of the body.

5. The portable terminal according to claim 4, wherein the body has at least one of a character and an image, and the scaling control module determines the area displaying the body on the display screen by changing a size of the character and the image of the body.

6. A method for controlling a portable terminal having a display screen for displaying a plurality of emails on the display screen, comprising the steps of:
receiving a plurality of emails each having a body;
displaying the body of the email on the display screen;
detecting the last of the body displayed on the display screen; and
displaying on the display screen a list of the plurality of the emails and status of each of the emails indicating whether the last of the body of each of the emails has been displayed.

7. A computer readable medium storing a program for controlling a portable terminal having a display screen for displaying a plurality of emails on the display screen, the program performing a process comprising the steps of:
receiving a plurality of emails each having a body;
displaying the body of the email on the display screen;
detecting the last of the body displayed on the display screen; and
displaying on the display screen a list of the plurality of the emails and status of each of the emails indicating whether the last of the body of each of the emails has been displayed.
